(19) United States
(12) Patent Application Publication
(10) Pub. No.: US 2006/0064748 A1
(43) Pub. Date: Mar. 23, 2006

(54) Detection of encrypted packet streams using process variation and/or multiple processes

(76) Inventors: Jeffrey A. Aaron, Atlanta, GA (US); Edgar Vaughan Shrum JR., Smyrna, GA (US)

Correspondence Address: SCOTT P. ZIMMERMAN, PLLC, PO BOX 3822, CARY, NC, 27519, US

(21) Appl. No.: 10/943,590

(22) Filed: Sep. 17, 2004

(51) Int. Cl. G06F 15/16

(52) U.S. Cl. 726/13

(57) ABSTRACT

Methods, systems, and devices are disclosed for detecting encrypted Internet Protocol packet streams. An encrypted stream of packets is received, with the encryption obscuring the type of data within the stream of packets. The type of data contained within the encrypted stream of packets is inferred using at least one of i) a set of variables comprising at least one of an observable parameter, a threshold value, a range of values, a timer, and an algorithm, and ii) multiple processes. Varying the selection of the variables thwarts hacking attempts, and the multiple processes enhance effectiveness and reliability.

### CROSS-REFERENCE TO RELATED APPLICATIONS

This application relates to the commonly assigned and concurrently filed U.S. application Ser. No. ______, entitled “Detection of Encrypted Packet Streams” (Attorney Docket BS040215); Ser. No. ______, entitled “Signature Specification for Encrypted Packet Streams” (Attorney Docket BS040216); Ser. No. ______, entitled “Detection of Encrypted Packet Streams” (Attorney Docket BS040278); Ser. No. ______, entitled “Detection of Encrypted Packet Streams Using a Timer” (Attorney Docket BS040279); and Ser. No. ______, entitled “Detection of Encrypted Packet Streams Using Feedback Probing” (Attorney Docket BS040281). These commonly-assigned applications are all incorporated by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to communications and, more particularly, to inferring data types in encrypted data streams.

Encryption of communications is increasing. More and more people, businesses, and governments are encrypting their electronic communications. This encryption provides enhanced security and privacy for these electronic communications.

Encryption, however, is a problem for communications service providers. Communications service providers need to know the type of data contained within an electronic communication. Some data types receive priority processing, while other data types are queued for later processing. Encryption, however, hides the contents of the communication and often prevents a communications service provider from determining the level of required processing. Because the communications service provider cannot determine the level of required processing, the encrypted communication defaults to lesser priority and/or processing.

Internet telephony provides an example. Internet telephone calls should be processed to result in a real time, or nearly real time, conversation. If packets are lost, or if packets experience congestion, the quality of the call suffers. Internet telephone calls, then, should receive priority processing. When a communications service provider detects data representing an Internet telephone call, the service provider gives that data priority/special processing to reduce packet loss and to reduce latency effects. Encryption, however, hides the contents of the communication. Encryption prevents the communications service provider from determining whether priority and/or special processing is required. So, even though the communication is an Internet telephone call, encryption causes the communication to default to lesser priority and/or processing. The quality of the call may then suffer from packet loss and congestion.

There is, accordingly, a need in the art for improved determination of data types. When parties encrypt their communications, there is a need for determining the type of data contained inside the encrypted communication. There is also a need for identifying a particular kind of encrypted traffic in order to provide prioritized/specialized processing.

### SUMMARY

The aforementioned problems, and other problems, are reduced, according to exemplary embodiments, using methods, computer systems, computer programs, and computer program products that detect the type of data contained within an encrypted stream of packets. According to the exemplary embodiments, the existence of one or more parameters within the encrypted stream of packets is noted. The one or more parameters are observable, despite encryption obscuring the contents of the encrypted stream of packets. The observable parameters are then used to infer the type of data contained within the encrypted stream of packets. An inference is made whether the encrypted stream of packets contains, for example, video data, picture data, text data, and/or or voice data. According to the exemplary embodiments, the inference may be made using a set of variables and/or multiple processes. The set of variables is selected using at least one of an observable parameter, a threshold value, a range of values, a timer, and an algorithm. Whatever variables are selected, the selection is varied, both in composition and in frequency, to thwart hacking and/or manipulation of system/network parameters. The use of the multiple processes creates a more reliable and effective inference of what type of data is contained within the encrypted stream of packets.

The exemplary embodiments receive an encrypted stream of packets. The encryption obscures the type of data within the stream of packets. The exemplary embodiments, however, are able to infer the type of data using at least one of i) a set of variables comprising at least one of an observable parameter, a threshold value, a range of values, a timer, and an algorithm, and ii) multiple processes.

Yet more exemplary embodiments describe a system having a communications module that infers a type of data within an encrypted stream of packets. The communications module infers the type of data within the encrypted stream of packets using at least one of i) a set of variables and ii) multiple processes. The set of variables comprises at least one of an observable parameter, a threshold value, a range of values, a timer, and an algorithm.

According to another of the embodiments, a computer program product may be used for inferring data types contained within encrypted packet streams. This computer program product includes computer instructions for receiving the encrypted stream of packets and inferring the type of data using at least one of i) a set of variables and ii) multiple processes. The set of variables comprises at least one of an observable parameter, a threshold value, a range of values, a timer, and an algorithm.

The exemplary embodiments may infer any type of data. The exemplary embodiments may infer the presence of video data, voice data (such as Voice Over Internet Protocol data), picture data, text data, and all other types of data. The exemplary embodiments, for example, may be used to infer the presence of on-line gaming sessions, simulations, virtual reality, email, messaging, multimedia-conferencing, application-sharing, e-voting, group-ware & collaboration, and any sort or type of video data. The exemplary embodiments can be applied to any encrypted stream which still contains observable parameters having some correlation to the type of data and/or the type of application/service and/or the specific application/service. The concepts described herein can help not just the type of data or application being used and communicating within the encrypted stream, but the concepts can also help identify the actual vendor-make, model, and version of a software application being used (e.g., Vendor A may use different packet sizes than Vendor B, and version 3 from Vendor A uses different inter-packet timing than version 1 from Vendor A). Whenever an encrypted stream contains observable parameters, the exemplary embodiments described herein exploit any correlation to the observable parameters.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

These and other features, aspects, and advantages of the embodiments of the present invention are better understood when the following Detailed Description is read with reference to the accompanying drawings, wherein:

FIG. 1 is a schematic illustrating the exemplary embodiments;

FIG. 2 is a schematic further illustrating the exemplary embodiments; and

FIG. 3 is a flowchart illustrating a method of detecting encrypted streams pf packets, according to more exemplary embodiments.

### DETAILED DESCRIPTION

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

According to the exemplary embodiments, the type of data contained within an encrypted stream of packets is detected. The existence of one or more parameters within the encrypted stream of packets is noted. The one or more parameters are observable, despite encryption obscuring the contents of the encrypted stream of packets. The observable parameters are then used to infer the type of data contained within the encrypted stream of packets. An inference is made whether the encrypted stream of packets contains, for example, video data, picture data, text data, and/or or voice data. According to the exemplary embodiments, the inference may be made using a set of variables and/or multiple, simultaneous algorithms. The set of variables is selected using at least one of an observable parameter, a threshold value, a range of values, a timer, and an algorithm. Whatever variables are selected, the selection is varied, both in composition and in frequency, to thwart hacking and/or manipulation of system/network parameters. The use of the multiple processes creates a more reliable and effective inference of what type of data is contained within the encrypted stream of packets.

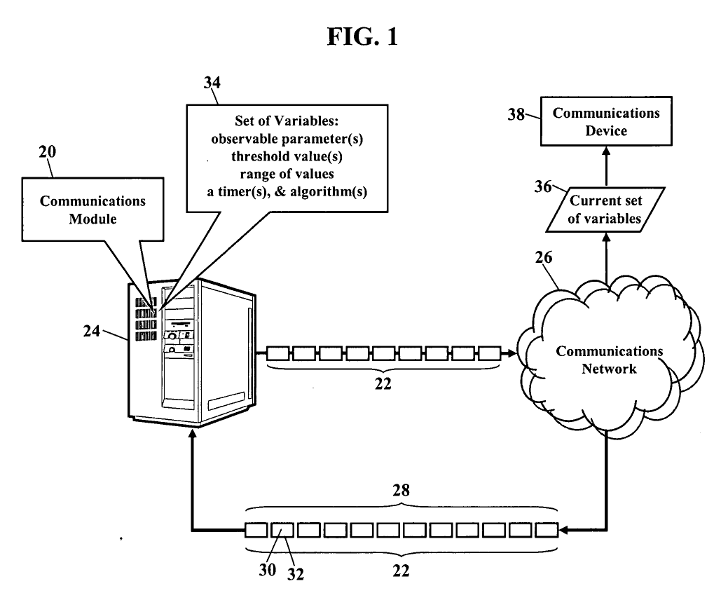

FIG. 1 is a schematic illustrating the exemplary embodiments. A communications module 20 comprises methods, systems, computer programs, and/or computer program products that help provide communications services. The communications module 20 detects an encrypted stream 22 of Internet Protocol packets. The communications module 20 operates within any computer system, such as a communications server 24. The communications module 20 receives the encrypted stream 22 of packets via a communications network 26. The communications network 26 may be a cable network operating in the radio-frequency domain and/or the Internet Protocol (IP) domain. The communications network 26, however, may also include a distributed computing network, such as the Internet (sometimes alternatively known as the “World Wide Web”), an intranet, a local-area network (LAN), and/or a wide-area network (WAN). The communications network 26 may include coaxial cables, copper wires, fiber optic lines, and/or hybrid-coaxial lines. The communications network 26 may even include wireless portions utilizing any portion of the electromagnetic spectrum and any signaling standard (such as the various cellular standards CDMA, TDMA, GSM, and/or the I.E.E.E. 802 family of standards). Because the stream 22 of packets is encrypted, the encryption obscures the contents of the stream 22 of packets. The communications module 20, however, is able to discern one or more observable parameters 28 within the encrypted stream 22 of packets. The communications module 20 is able to observe the parameters 28, despite encryption obscuring the contents 30 of each packet 32 within the stream 22 of packets. Each observable parameter 28 describes some characteristic that might be observed within the stream 22 of packets, despite the encryption. Although there are many observable parameters, this patent will not describe in detail the observable parameters 28. If the reader desires to learn more about the observable parameters 28, the reader is invited to consult the commonly assigned and concurrently filed U.S. application Ser. No. ______, entitled “Detection of Encrypted Packet Streams” (Attorney Docket BS040215), incorporated herein by reference.

The communications module 20 compares the observable parameters 28 to the actual characteristics of the encrypted stream 22 of packets. The communications module 20 observes the stream 22 of packets and notes whether any of the observable parameters 28 occurs and/or exists within the encrypted stream 22 of packets. The communications module 20 compares the observable parameters 28 to threshold values and infers the type of data contained within the encrypted stream 22 of packets.

When the type of data is inferred, the communications module 20 may utilize a set 34 of variables. The set of variables is selected using at least one of an observable parameter, a threshold value, a range of values, a timer, and an algorithm. The parameter 28 describes some characteristic that might be observed within the stream 22 of packets, despite encryption obscuring the contents 30 of each packet 32. The threshold value, and/or the range of values, describes a known characteristic of a known type of data. The threshold value, for example, might be known packet size(s), timing value(s), pattern(s), or other characteristics for packets containing video data, text file data, audio data, picture data, and/or any other known type of data. The timer(s) forcibly maintain network and/or system settings, despite changes in the observable parameters and/or the inferred type of data. The algorithm(s) can be any logical rule(s) and/or mathematical expression(s) that may help the communications module 20 infer the type of data contained within the encrypted packet 32. Although the set 34 of variables may have many components, this patent will not describe in detail the set 34 of variables. If the reader desires to learn more about the set 34 of variables, the reader is invited to consult the commonly assigned and concurrently filed U.S. applications Ser. No. ______, entitled “XXXXX” (Attorney Docket BS040215); Ser. No. ______, entitled “______” (Attorney Docket BS040216); Ser. No. ______, entitled “______” (Attorney Docket BS040278); Ser. No. ______, entitled “______” (Attorney Docket BS040279); and Ser. No. ______, entitled “______” (Attorney Docket BS040281). These commonly-assigned applications are all incorporated by reference.

Whatever the set 34 of variables, the set 34 of variables is varied, both in composition and in frequency, to thwart hacking. When the communications module 20 infers what type of data is contained within the encrypted stream 22 of packets, the communications module 20 can vary the set 34 of variables to deter purposeful manipulation of system and/or network parameters. The exemplary embodiments may vary the process that infers data types to deter hacking. Because the set 34 of variables can vary in composition and with time, a potential hacker would have difficulty determining how the communications module 20 infers data types. The communications module 20 randomly or deterministically selects the set 34 of variables to vary its composition. Should someone with malicious intentions try to conceal the true type of data contained within the encrypted stream 22 of packets, the potential hacker would first have to determine, at that moment, the composition of the randomly/deterministically selected set 34 of variables. Because the set 34 of variables is randomly or deterministically selected at various times, the changing composition of the set 34 of variables would be difficult to determine. The communications module 20, then, selects the set 34 of variables to thwart hacking.

The set 34 of variables, then, may randomly vary. The communications module 20 may use a random selection of the variables within the set 34. That is, when the communications module 20 infers the type of data contained within the encrypted stream 22 of packets, the communications module 20 randomly selects the variables and process that it uses to infer data types. The communications module 20, for example, may randomly select from one or more of the observable parameters, one or more of the threshold values and/or range of values, and one or more of the timers. The communications module 20 may even randomly select what algorithm is used to infer data types.

The set 34 of variables may periodically vary. The communications module 20 may use a periodically varying set of variables when inferring data types. The set 34 of variables may periodically vary according to time, to a schedule, or to a counter. The set 34 of variables, for example, may periodically vary every thirty (30) seconds, every five (5) minutes, every hour, or any other interval of time from nanoseconds to many hours. The set 34 of variables may periodically vary each morning, every other day, once per week, once per month, or any other calendar schedule. The communications module 20 may even establish a counter, such that when the counter reaches a limit or stop value, the set 34 of variables then changes. The counter, for example, may count bits/bytes of data that are received by the communications module 20 and then vary the set 34 of variables every billion bits, every terra bit, or any other value. The counter may also count the number of inferred voice streams, video streams, email streams, or any other type of data. The counter may even vary the set 34 of variables with each Voice Over Internet Protocol session. However the set 34 of variables may periodically vary, the communications module 20 selects the set 34 of variables to help thwart hacking.

Even though the set 34 of variables may vary, the communications network 20 may inform upstream and downstream processes. When the communications module 20 varies the set 34 of variables, the communications module 20 keeps authorized communications devices up-to-date with the latest settings. Whatever the composition of the set 34 of variables, at any moment in time, that current composition is communicated to any other communications devices that should be informed. The communications module 20 communicates a current set 36 of variables via the communications network 26. The communications module 20, for example, may communicate the current set 36 of variables to a communications device 38 originating/terminating the stream 22 of packets.

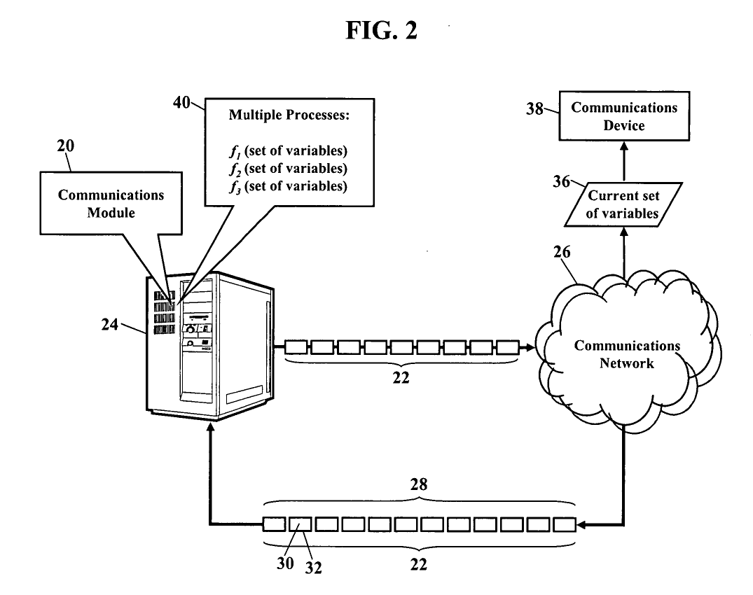

FIG. 2 is a schematic further illustrating the exemplary embodiments. When the communications module 20 infers the type of data contained within the stream 22 of packets, the communications module 20 may utilize multiple processes 40. That is, the communications module 20 uses two or more algorithms, and each algorithm separately infers the type of data contained within the stream 22 of packets. Each of the multiple processes 40 may utilize any mathematical expression, involving any combination of the set 34 of variables. The multiple processes 40 may simultaneously launch and/or operate, such that the communications module 20 is able to compare the result(s) from each algorithm. Because the communications module 20 uses the multiple processes 40, the communications module 20 can have greater reliability and effectiveness when inferring. The communications module 20, for example, may require unanimously agreement among the multiple processes 40 as to the type of data encrypted within the stream of packets. If the results do not unanimously agree, then the communications module could decline to infer the type of data. The communications module 20, alternatively, may require only a majority of the multiple processes 40 agree to the type of data encrypted within the stream of packets. Some disagreement is permissible, as long as a majority concur. The communications module 20 may only require that some of the multiple processes 40 agree for a period of time as to the type of data encrypted within the stream of packets. Because the stream 22 of packets may instantaneously change, the multiple processes 40 may only agree for milliseconds, for seconds, or for some other interval of time. As long as some threshold is met—that is, some of the multiple processes 40 agree for some threshold interval of time—the communications module 20 has the authority, and the confidence, to infer data types.

The multiple processes 40 may have any form. That is, the multiple processes 40 may utilize any mathematical expression or relationship, involving any combination of the set 34 of variables. Although a complete listing of all the possible processes is cumbersome, the following paragraphs describe some classes of processes that may be used.

Classes 1 and 2—Processes that Keep State, Verses Processes that Do Not Keep State

A communication, such as a VoIP conversation, can actually consist of multiple different types of exchanges between communicators. These exchanges occur in a certain known sequence, for instance associated with network protocol (e.g., SIP or Session Initiation Protocol in the case of VoIP) definitions and operation. The current state of the overall exchange is the point in the sequence currently achieved. Some detection processes may keep track of the current overall state in order to achieve more accurate results, to achieve proper detection functioning, or for other reasons.

Classes 3 and 4—Processes which Adapt Versus Processes which Do Not Adapt

Some detection processes may adapt to previous results. Some processes, for example, may adjust their algorithms and/or parameters used to obtain a result. As a more specific example, previous results can be compared to one or more thresholds, and three different algorithms may be available to obtain a result, one each associated with the “low,” “medium,” or “high” previous result or weighted average of previous results.

Classes 5 and 6—Processes which Continually Vary their Own Parameters Versus Processes which Do Not

Some detection processes may incorporate variation of parameters as an integral part of their function. These detection processes may vary one or more associated process-internal parameters in order to achieve a final result, and this is not optional but is essential to the effective functioning of the process.

Classes 7 and 8—Processes which Filter Ambiguous Intermediate or Tentative Results Versus Processes which Do Not

Some detection processes may apply an intermediate test to eliminate one or more intermediate, tentative, and/or partial results. These results may be deemed too uncertain to be useful, rather than incorporating those values into a final result determination. For instance, an uncertainty measurement may be computed for each intermediate or tentative result, and discarding may be accomplished when the associated uncertainty exceeds an unacceptable threshold.

Classes 9 and 10—Processes which Guess Versus Processes which Do Not

Rather than straightforwardly determining outputs from inputs, for each detection instance some detection processes may first postulate a detection result, and then conduct computations to either verify or disprove the assumed detection. The actual computations to verify and to disprove may be separate. “Guesses” may be partly based on the history or previous results, and/or partly on seemingly unrelated inputs, such as ambient temperature, time of day, day of the week, etc.

Classes 11 and 12—Processes which Employ a Series of Conditional Stages and Those that Do Not

Some detection processes may achieve a final result via two or more sequential stages, where the computational algorithm and/or parameters of a particular stage may be chosen from among a set of options by applying some sort of test to the result of the previous stage, for example by means of comparing the preceding stage's result to one or more thresholds. As a more specific example, three different algorithms may be available for a particular stage, one each associated with the low, medium, or high result which may be produced by a preceding stage.

When the communications module 20 utilizes the multiple processes 40, the processes may be diverse. That is, the communications module 20 may use two or more processes, and each is a different process (for instance, the processes are chosen from a different process class described above). The multiple processes may would be simultaneously used. By using different processes at the same time, both redundancy of processing and reliability of processing are improved. Reliability is improved in the sense that, when multiple different processes agree on a result, one can be more certain that the result is true than when only one singular process has achieved that result. (Note that using multiple identical processes would be less valuable, accruing only a gain in redundancy of processing, but not in reliability as described). Each different process, being different in some significant way, would potentially provide at least a slightly different result even when given identical inputs. Because detection processes are never perfect, but always have some associated impreciseness and/or unreliability, the processes lead to a non-zero margin or error. For a given detection process, this can vary depending on inputs, environmental conditions, and network conditions. Further, different detection processes exhibit this impreciseness/unreliability/uncertainty in different ways. Therefore, by simultaneously utilizing multiple different processes with a means of suitably combining their individual results into a final overall result, such process-dependent vagaries can be averaged out, leading to a reduction in overall uncertainty and thus better results.

When the communications module 20 varies the set 34 of variables, the communications module 20 may utilize different strategies. One such strategy is to keep the same process but vary one or more associated parameters, thresholds, etc. Another strategy is to vary the actual detection process used, for instance by picking processes from different ones of the classes mentioned above each time variation is employed. (Note that variation is meaningless unless something is changed, so if a different process is not selected, then only the parameters, thresholds, etc. can be changed.) If desired, the two variation methods can be combined, and in fact this would be the preferred approach for maximum variability.

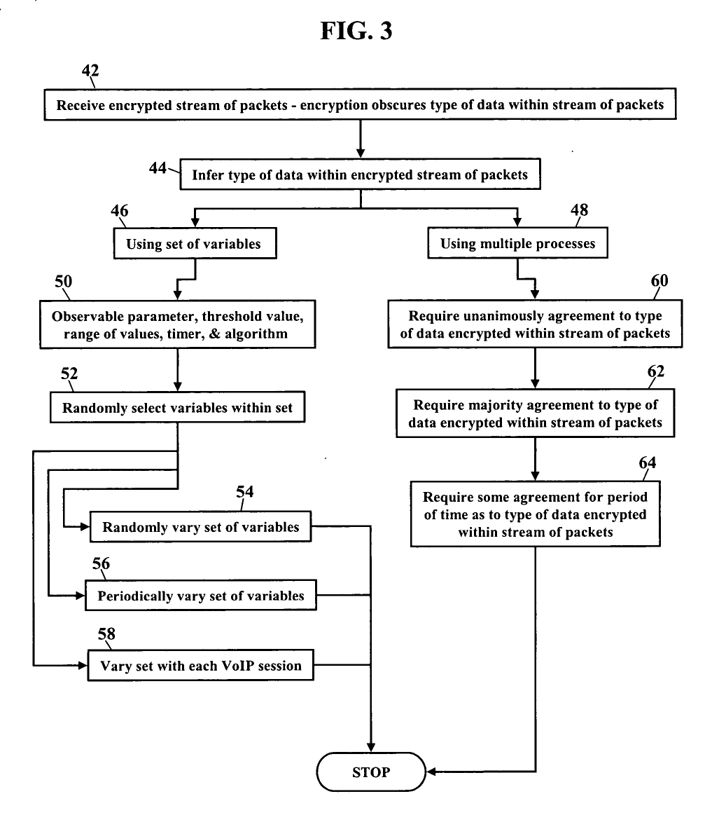

FIG. 3 is a flowchart illustrating a method of detecting encrypted packet streams, according to more exemplary embodiments. An encrypted stream of packets is received (Block 42), and the encryption obscures a type of data within the stream of packets. The type of data within the encrypted stream of packets is inferred (Block 44) using at least one of i) a set of variables (Block 46) and/or multiple processes (Block 48). The set of variables may comprise at least one of an observable parameter, a threshold value, a range of values, a timer, and an algorithm, and ii) multiple processes (Block 50). A random selection of the variables within the set may be used (Block 52), and the set of variables may be randomly varied (Block 54) and/or periodically varied (Block 56). The set of variables may even be varied with each Voice Over Internet Protocol (VoIP) session (Block 58). When multiple processes are used to infer data types, unanimously agreement (Block 60), majority agreement (Block 62), and/or some agreement (Block 64) may be required for a period of time.

The communications module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the communications module to be easily disseminated. A computer program product for detecting the type of data contained within an encrypted stream of packets includes the communications module stored on the computer-readable medium. The communications module includes computer-readable instructions for receiving an encrypted stream of packets, with the encryption obscuring the type of data within the stream of packets. The communications module, however, is able to infer the type of data within the encrypted stream of packets using at least one of i) a set of variables comprising at least one of an observable parameter, a threshold value, a range of values, a timer, and an algorithm, and ii) multiple processes.

The communications module may also be physically embodied on or in any addressable (e.g., HTTP, I.E.E.E. 802.11, Wireless Application Protocol (WAP)) wire line or wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A method, comprising the steps of:
receiving an encrypted stream of packets, the encryption obscuring a type of data within the stream of packets; and
inferring the type of data within the encrypted stream of packets using at least one of
i) a set of variables comprising at least one of an observable parameter, a threshold value, a range of values, a timer, and an algorithm, and
ii) multiple processes.

2. A method according to claim 1, wherein the step of inferring the type of data comprises using a random selection of the variables within the set.

3. A method according to claim 1, wherein the step of inferring the type of data comprises varying the set of variables.

4. A method according to claim 1, wherein the step of inferring the type of data comprises periodically varying the set of variables.

5. A method according to claim 1, wherein the step of inferring the type of data comprises randomly varying the set of variables.

6. A method according to claim 1, wherein the step of inferring the type of data comprises varying the set of variables with each Voice Over Internet Protocol session.

7. A method according to claim 1, wherein the step of inferring the type of data comprises at least one of i) requiring that the multiple processes unanimously agree to the type of data encrypted within the stream of packets, ii) requiring that a majority of the multiple processes agree to the type of data encrypted within the stream of packets, and ii) requiring that some of the multiple processes agree for a period of time as to the type of data encrypted within the stream of packets.

8. A system, comprising:
a communications module stored in a memory device, and a processor communicating with the memory device;
the communications module receiving an encrypted stream of packets, the encryption obscuring the type of data within the stream of packets, and the communications module inferring the type of data within the encrypted stream of packets using at least one of
i) a set of variables comprising at least one of an observable parameter, a threshold value, a range of values, a timer, and an algorithm, and
ii) multiple processes.

9. A system according to claim 8, wherein the communications module uses a random selection of the variables within the set.

10. A system according to claim 8, wherein the communications module varies the set of variables.

11. A system according to claim 8, wherein the communications module periodically varies the set of variables.

12. A system according to claim 8, wherein the communications module randomly varies the set of variables.

13. A system according to claim 8, wherein the communications module varies the set of variables with each Voice Over Internet Protocol session.

14. A system according to claim 8, wherein the communications module requires at least one of i) the multiple processes unanimously agree to the type of data encrypted within the stream of packets, ii) a majority of the multiple processes agree to the type of data encrypted within the stream of packets, and ii) some of the multiple processes agree for a period of time as to the type of data encrypted within the stream of packets.

15. A computer program product comprising a computer readable medium including instructions for performing the steps:
receiving an encrypted stream of packets, the encryption obscuring the type of data within the stream of packets; and
inferring the type of data within the encrypted stream of packets using at least one of
iii) a set of variables comprising at least one of an observable parameter, a threshold value, a range of values, a timer, and an algorithm, and
iv) multiple processes.

16. A computer program product according to claim 15, further performing the step of using a random selection of the variables within the set.

17. A computer program product according to claim 15, further performing the step of varying the set of variables.

18. A computer program product according to claim 15, further performing at least one of the steps of i) periodically varying the set of variables and ii) randomly varying the set of variables.

19. A computer program product according to claim 15, further performing the step of varying the set of variables with each Voice Over Internet Protocol session.

20. A computer program product according to claim 15, further performing at least one of the steps of i) requiring that the multiple processes unanimously agree to the type of data encrypted within the stream of packets, ii) requiring that a majority of the multiple processes agree to the type of data encrypted within the stream of packets, and ii) requiring that some of the multiple processes agree for a period of time as to the type of data encrypted within the stream of packets.
